(19) United States
(12) Patent Application Publication
(10) Pub. No.: US 2024/0424785 A1
(43) Pub. Date: Dec. 26, 2024

(54) LIQUID EJECTING HEAD AND LIQUID EJECTING APPARATUS

(71) Applicant: SEIKO EPSON CORPORATION, Tokyo (JP)

(72) Inventors: Yu SHIOZAWA, SHIOJIRI-SHI (JP); Shingo TOMIMATSU, SHIOJIRI-SHI (JP); Motoki TAKABE, SHIOJIRI-SHI (JP)

(21) Appl. No.: 18/748,376

(22) Filed: Jun. 20, 2024

(30) Foreign Application Priority Data
Jun. 22, 2023 (JP) 2023-102719
Jul. 19, 2023 (JP) 2023-117612

(51) Int. Cl. B41J 2/14; B41J 2/045

(52) U.S. Cl. CPC B41J 2/14201; B41J 2/04541

(57) ABSTRACT

A liquid ejecting head includes a nozzle substrate that is provided with a nozzle for ejecting a liquid, a pressure chamber substrate that includes a pressure chamber in which pressure for ejecting the liquid from the nozzle is applied to the liquid, and an absorption chamber that is adjacent to the pressure chamber and absorbs vibration of the liquid generated when the pressure is applied to the liquid in the pressure chamber, a first piezoelectric member that is provided corresponding to the pressure chamber and applies pressure to the pressure chamber when a voltage is applied, a second piezoelectric member that is provided corresponding to the absorption chamber, and a pressure acquisition portion that acquires pressure of the absorption chamber based on a voltage applied to the second piezoelectric member.

The present application is based on, and claims priority from JP Application Serial Number 2023-102719, filed Jun. 22, 2023, and JP Application Serial Number 2023-117612, filed Jul. 19, 2023, the disclosures of which are hereby incorporated by reference herein in their entirety.

### BACKGROUND

### 1. Technical Field

The present disclosure relates to a liquid ejecting head and a liquid ejecting apparatus.

### 2. Related Art

In the related art, a liquid ejecting apparatus including a plurality of heads ejecting a liquid such as ink to a medium such as printing paper is proposed. In recent years, ink jet printers have attracted attention not only for printing applications but also as apparatuses that can apply a material that can be liquidized to any location. The ink jet printer includes a liquid ejecting head that ejects a liquid. As the liquid ejecting head, a head that ejects a liquid filled in a pressure chamber from a nozzle by vibrating a vibration plate constituting a wall surface of the pressure chamber with a piezoelectric element is known.

The liquid ejecting head disclosed in JP-A-2018-153926 includes a pressure chamber and a liquid storage chamber provided at a position different from the pressure chamber. Since the liquid storage chamber is provided, the pressure fluctuation due to the liquid can be effectively absorbed, and thus the stability of the ejection of the liquid from the nozzle is improved.

However, in the liquid ejecting head disclosed in JP-A-2018-153926, the pressure chamber and the liquid storage chamber are provided at positions spaced apart from each other through many members. Therefore, the absorption efficiency of the liquid vibration in the pressure chamber is low. It is considered that the absorption efficiency of the liquid vibration can be improved by providing the liquid storage chamber at the adjacent position of the pressure chamber.

Meanwhile, in the liquid ejecting head, the behavior of the liquid and the like changes largely depending on the pressure of the pressure chamber. Therefore, acquiring the pressure was an object in the related art. The inventors have found a configuration in which the pressure in the vicinity of the pressure chamber can be detected with a simple configuration by using the liquid storage chamber in a form in which the liquid storage chamber is provided at a position adjacent to the pressure chamber described above.

### SUMMARY

According to an aspect of the present disclosure, a liquid ejecting head includes a nozzle substrate that is provided with a nozzle for ejecting a liquid, a pressure chamber substrate that includes a pressure chamber in which pressure for ejecting the liquid from the nozzle is applied to the liquid, and an absorption chamber that is adjacent to the pressure chamber and absorbs vibration of the liquid generated when the pressure is applied to the liquid in the pressure chamber, a first piezoelectric member that is provided corresponding to the pressure chamber and applies pressure to the pressure chamber when a voltage is applied, a second piezoelectric member that is provided corresponding to the absorption chamber, and a pressure acquisition portion that acquires pressure of the absorption chamber based on a voltage applied to the second piezoelectric member.

### BRIEF DESCRIPTION OF THE DRAWINGS

FIG. 1 is a schematic view illustrating a configuration of a liquid ejecting apparatus according to a first embodiment.

FIG. 2 is a block diagram of the liquid ejecting apparatus in FIG. 1.

FIG. 3 is a partial cross-sectional view of a liquid ejecting head illustrated in FIG. 1.

FIG. 4 is a view illustrating a portion of a pressure chamber substrate in FIG. 3.

FIG. 5 is a view illustrating a portion of a sealing substrate in FIG. 3.

FIG. 6 is a graph illustrating an example of a relationship between electrostatic capacitance and pressure of a second piezoelectric member.

FIG. 7 is a view illustrating a second piezoelectric element and a third piezoelectric element in FIG. 2.

FIG. 8 is a plan view illustrating a second piezoelectric element in a second embodiment.

FIG. 9 is a plan view illustrating a second piezoelectric element in a third embodiment.

FIG. 10 is a block diagram of a liquid ejecting apparatus in a modification example.

FIG. 11 is a cross-sectional view of a first piezoelectric element and a second piezoelectric element in the modification example.

FIG. 12 is a cross-sectional view of the first piezoelectric element and the second piezoelectric element in the modification example.

FIG. 13 is a partial cross-sectional view of a liquid ejecting head in the modification example.

### DESCRIPTION OF EMBODIMENTS

Hereinafter, preferred embodiments according to the present disclosure will be described with reference to the accompanying drawings. In the drawings, the dimensions or scales of the respective portions are appropriately different from the actual dimensions or scales, and some portions are schematically illustrated for easy understanding. Further, the scope of the present disclosure is not limited to these forms unless it is stated in the following description that the present disclosure is particularly limited. The phrase “element β on element α” is not limited to a configuration in which the element α is in direct contact with the element β, and also includes a configuration in which the element α is not in direct contact with the element β.

### 1. First Embodiment

### 1-1. Overall Configuration of Liquid Ejecting Apparatus 100

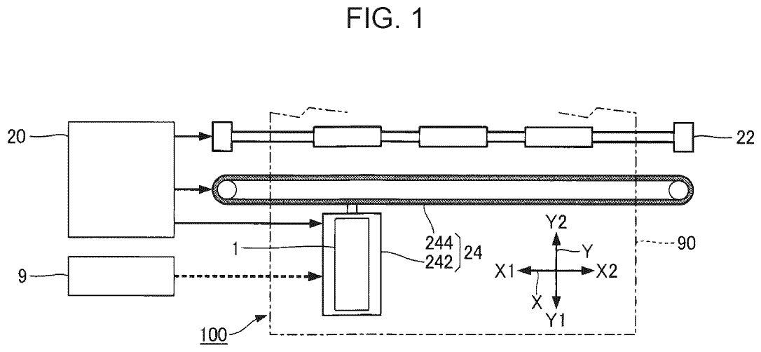

FIG. 1 is a schematic view illustrating a configuration of a liquid ejecting apparatus 100 according to a first embodiment. For convenience of description, the description will be made below by appropriately using an X-axis, a Y-axis, and a Z-axis which are perpendicular to one another. In addition, one direction along the X-axis is referred to as an X1 direction, and a direction opposite to the X1 direction is referred to as an X2 direction. Similarly, one direction along the Y-axis is referred to as a Y1 direction, and a direction opposite to the Y1 direction is referred to as a Y2 direction. One direction along the Z-axis is referred to as a Z1 direction, and a direction opposite to the Z1 direction is referred to as a Z2 direction.

The liquid ejecting apparatus 100 in FIG. 1 is an ink jet printing apparatus that ejects an ink, which is an example of a liquid, to a medium 90. The medium 90 is typically printing paper, but a printing target of an arbitrary material such as a resin film or a cloth is used as the medium 90. As illustrated in FIG. 1, a liquid container 9 that stores an ink is installed in the liquid ejecting apparatus 100. For example, a cartridge that is attachable to and detachable from the liquid ejecting apparatus 100, a bag-shaped ink pack formed by a flexible film, or an ink tank that can be replenished with an ink is used as a liquid container 9.

The liquid ejecting apparatus 100 includes a control unit 20, a medium transport mechanism 22, a moving mechanism 24, and a liquid ejecting head 1. The control unit 20 includes, for example, one or a plurality of processing circuits such as a central processing unit (CPU) or a field programmable gate array (FPGA), and one or a plurality of storage circuits such as a semiconductor memory, and controls each element of the liquid ejecting apparatus 100 in an integrated manner.

The medium transport mechanism 22 transports the medium 90 in a direction along the Y-axis under the control of the control unit 20. Further, the moving mechanism 24 causes the liquid ejecting head 1 to reciprocate along the X-axis under the control of the control unit 20. The moving mechanism 24 includes a substantially box-shaped transport member 242 that accommodates the liquid ejecting head 1, and a transport belt 244 to which the transport member 242 is fixed. A configuration in which a plurality of the liquid ejecting heads 1 are mounted on the transport member 242, or a configuration in which the liquid container 9 is mounted on the transport member 242 together with the liquid ejecting head 1 may be adopted.

The liquid ejecting head 1 ejects the ink supplied from the liquid container 9, from a plurality of nozzles to the medium 90 under the control of the control unit 20. Each liquid ejecting head 1 ejects the ink to the medium 90 in parallel with the transport of the medium 90 by the medium transport mechanism 22 and the repetitive reciprocation of the transport member 242, whereby an image is formed at a surface of the medium 90.

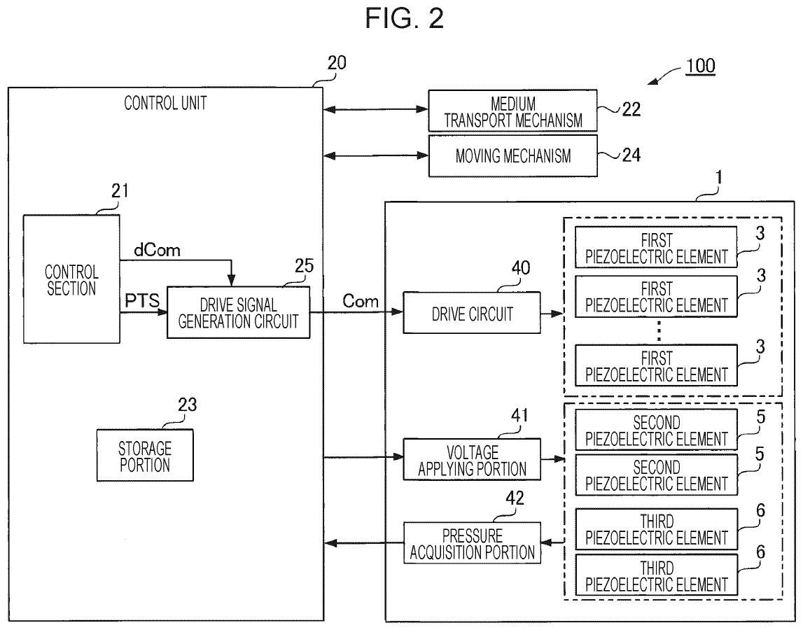

FIG. 2 is a block diagram of the liquid ejecting apparatus 100 in FIG. 1. As illustrated in FIG. 2, the liquid ejecting apparatus 100 includes the control unit 20, the medium transport mechanism 22, the moving mechanism 24, and the liquid ejecting head 1. The control unit 20 includes a control section 21, a storage portion 23, and a drive signal generation circuit 25. The liquid ejecting head 1 includes a drive circuit 40, a plurality of first piezoelectric elements 3, a voltage applying portion 41, a pressure acquisition portion 42, one or more second piezoelectric elements 5, and one or more third piezoelectric elements 6.

The control section 21 includes, for example, one or more processing circuits such as a CPU or an FPGA. The control section 21 generates a signal for controlling the operation of each portion of the liquid ejecting apparatus 100. The control section 21 controls an ejection operation of the ink by the liquid ejecting head 1.

The control section 21 generates a print signal SI, a waveform designation signal dCom, and a timing signal PTS. The print signal SI is a digital signal for designating the type of operation of the liquid ejecting head 1. The print signal SI designates whether or not to supply a drive signal Com to the first piezoelectric element 3. The waveform designation signal dCom is a digital signal that defines a waveform of the drive signal Com. The drive signal Com is an analog signal for driving the first piezoelectric element 3. The timing signal PTS is a signal that defines a generation timing of the drive signal Com.

The storage portion 23 includes one or a plurality of storage circuits such as a semiconductor memory. The storage portion 23 stores print data Img supplied from a host computer. The storage portion 23 stores a control program of the liquid ejecting apparatus 100.

The drive signal generation circuit 25 includes a DA conversion circuit. The drive signal generation circuit 25 generates the drive signal Com having a waveform defined by the waveform designation signal dCom. The drive signal generation circuit 25 outputs the drive signal Com each time the timing signal PTS is received.

The drive circuit 40 switches whether or not to supply the drive signal Com to each first piezoelectric element 3 based on the print signal SI. The drive circuit 40 selects the first piezoelectric element 3 to which the drive signal Com is to be supplied, based on the print signal SI, a latch signal LAT, and a change signal CH, which are supplied from the control unit 20. The latch signal LAT defines a latch timing of print data Img. The change signal CH defines a selection timing of a drive pulse included in the drive signal Com.

The voltage applying portion 41 applies a predetermined voltage to the one or more second piezoelectric elements 5 and the one or more third piezoelectric elements 6. The voltage applying portion 41 includes, for example, a power supply circuit. The pressure acquisition portion 42 acquires the pressure of the absorption chamber S2 (described later) of the liquid ejecting head 1 based on the voltage applied to the second piezoelectric element 5. The pressure acquisition portion 42 includes, for example, a pressure detection element, and outputs a detection signal as a voltage value.

### 1-2. Liquid Ejecting Head 1

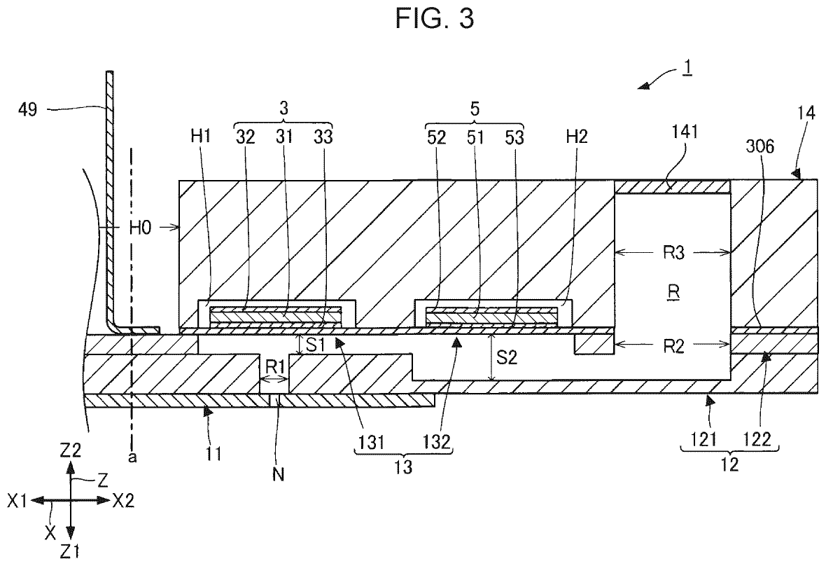

FIG. 3 is a partial cross-sectional view of the liquid ejecting head 1 illustrated in FIG. 1, and is a view of a cross section parallel to an X-Z plane. The Z-axis is an axis along an ink ejection direction by the liquid ejecting head 1. A direction along the Z-axis is set to an “up-down direction”. The Z2 direction is an example of “one side in the up-down direction”, and the Z1 direction is an example of “the other side in the up-down direction”. In addition, viewing from the direction along the Z-axis is set to a “plan view”. The Y1 direction or the Y2 direction is an example of a “first direction”. The X1 direction or the X2 direction is an example of a “second direction”.

The liquid ejecting head 1 in FIG. 3 has a structure that is substantially plane-symmetrical with respect to a virtual plane a along a Y-Z plane. In the following description, a configuration on the right side of the virtual plane a in FIG. 3 will be mainly described, and the description of a configuration on the left side of the virtual plane a in FIG. 3 will be appropriately omitted.

The liquid ejecting head 1 includes a nozzle substrate 11, a pressure chamber substrate 12, a vibration plate 13, a sealing substrate 14, a wiring substrate 49, a first piezoelectric element 3, and a second piezoelectric element 5. The first piezoelectric element 3 includes a first piezoelectric member 31, a first electrode 32, and a second electrode 33. The second piezoelectric element 5 includes a second piezoelectric member 51, a third electrode 52, and a fourth electrode 53. In addition, although not illustrated in detail, the nozzle substrate 11, the pressure chamber substrate 12, the vibration plate 13, and the sealing substrate 14 have a long plate shape along the Y-axis.

The nozzle substrate 11 is a plate-shaped member provided with a plurality of nozzles N that ejects ink, which is an example of a liquid. Each of the plurality of nozzles N is a circular through-hole through which the ink is ejected. The plurality of nozzles N are arranged linearly along the Y-axis. The nozzle substrate 11 is manufactured by processing a semiconductor substrate such as a single crystal substrate of silicon, for example.

The pressure chamber substrate 12 is a flow path structure in which a flow path for supplying the ink to each of the plurality of nozzles N is formed. The pressure chamber substrate 12 is a laminate of a first substrate 121 and a second substrate 122. Each of the first substrate 121 and the second substrate 122 is manufactured by processing a semiconductor substrate such as a single crystal substrate of silicon, for example. Each of the first substrate 121 and the second substrate 122 may be integrally formed. In addition, the pressure chamber substrate 12 may include a member other than the first substrate 121 and the second substrate 122.

The flow path of the ink is formed in the pressure chamber substrate 12. Specifically, a plurality of pressure chambers S1, an absorption chamber S2, a plurality of first communication flow paths R1, and a second communication flow path R2 are formed in the pressure chamber substrate 12. Each of the first substrate 121 and the second substrate 122 has a recess or a through-hole. The plurality of pressure chambers S1, the absorption chamber S2, the plurality of first communication flow paths R1, and the second communication flow path R2 are formed by the recesses or the through-holes.

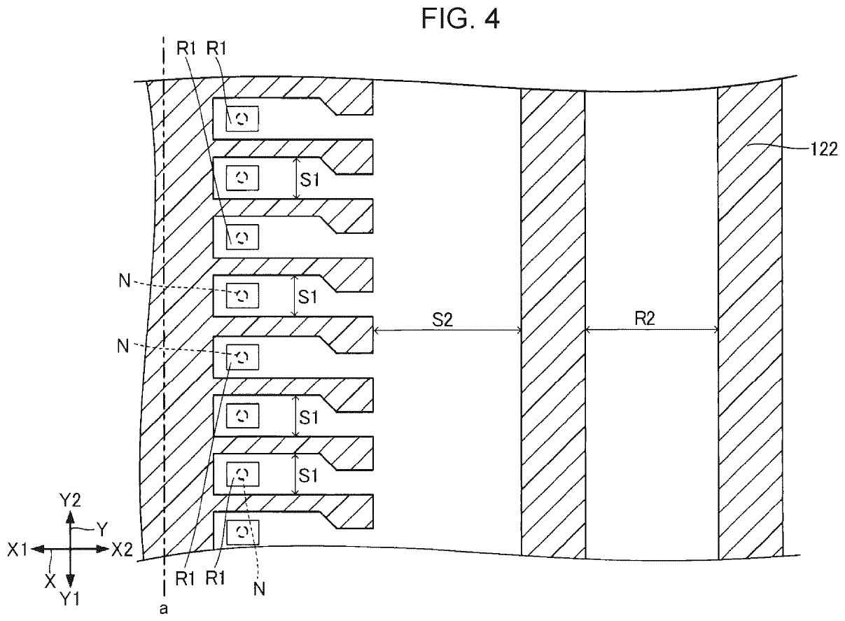

FIG. 4 is a view illustrating a portion of the pressure chamber substrate 12 in FIG. 3. As illustrated in FIG. 4, each pressure chamber S1 has a longitudinal shape extending in the X2 direction. The plurality of pressure chambers S1 are spaced apart from each other and are arranged in the Y2 direction. Thus, a direction in which the plurality of pressure chambers SI are arranged is the Y2 direction, which is the “first direction”. In addition, the plurality of pressure chambers S1 are provided in a one-to-one relationship with the plurality of nozzles N. Each pressure chamber S1 is a space in which pressure for ejecting the ink from the nozzle N is applied to the ink.

The plurality of first communication flow paths R1 are spaced apart from each other and are arranged in the Y2 direction. The plurality of first communication flow paths R1 are provided in a one-to-one relationship with the plurality of pressure chambers S1. Each of the first communication flow paths R1 communicates the corresponding pressure chamber S1 and the nozzle N. The respective first communication flow paths R1 overlap the corresponding pressure chambers S1 and the nozzles N in a plan view.

The absorption chamber S2 is provided upstream of the plurality of pressure chambers S1. A direction in which the pressure chambers S1 and the absorption chamber S2 are arranged is the X2 direction which is the “second direction”. The absorption chamber S2 has a longitudinal shape extending in the Y2 direction. The volume of the absorption chamber S2 is much larger than the volume of each pressure chamber S1. The absorption chamber S2 is provided in common to the plurality of pressure chambers S1 and is coupled to the plurality of pressure chambers S1. The absorption chamber S2 is adjacent to the pressure chamber S1 to absorb the vibration of the ink generated when the pressure is applied to the ink in the pressure chamber S1. By providing the absorption chamber S2, it is possible to stabilize the ejection performance of the ink. Further, since the absorption chamber S2 is adjacent to the pressure chamber S1, it is possible to enhance the absorption efficiency of the vibration of the ink as compared with a case where the absorption chamber S2 is spaced apart from the pressure chamber S1. As a result, it is possible to enhance the stability of the ejection performance of the ink.

The second communication flow path R2 is provided upstream of the absorption chamber S2 and is coupled to the absorption chamber S2. The second communication flow path R2 has a longitudinal shape extending in the Y2 direction.

As illustrated in FIG. 3, the vibration plate 13 is disposed on the surface of the pressure chamber substrate 12 in the Z2 direction. The thickness of the vibration plate 13 is much thinner than the thickness of each of the first substrate 121 and the second substrate 122 of the pressure chamber substrate 12. The thickness is a length in the Z1 direction. The vibration plate 13 is elastically deformable. The vibration plate 13 includes a plurality of first vibration plates 131 and a second vibration plate 132. The plurality of first vibration plates 131 and the second vibration plate 132 are formed by one member.

The plurality of first vibration plates 131 are provided in a one-to-one relationship with the plurality of pressure chambers S1. Each of the first vibration plates 131 is a portion of the vibration plate 13, which overlaps the plurality of pressure chambers S1 in a plan view. Each of the first vibration plates 131 forms a portion of the pressure chamber S1. Each of the first vibration plates 131 vibrates by applying a voltage to the first piezoelectric member 31 of the first piezoelectric element 3, thereby applying pressure to the pressure chamber S1. By providing the first vibration plate 131, the first piezoelectric element 3 can be provided on the pressure chamber S1, and thus it is possible to efficiently apply, to the pressure chamber S1, the pressure due to the vibration generated by applying a voltage to the first piezoelectric member 31 via the first vibration plate 131.

The second vibration plate 132 is a portion of the vibration plate 13, which overlaps the absorption chamber S2 in a plan view. The second vibration plate 132 forms a portion of the absorption chamber S2. The second vibration plate 132 drives by the pressure applied from the absorption chamber S2 to apply the pressure to the second piezoelectric member 51 of the second piezoelectric element 5. By providing the second vibration plate 132, the second piezoelectric element 5 can be provided on the absorption chamber S2, and thus it is possible to efficiently apply the pressure to the second piezoelectric member 51.

In addition, the plurality of first vibration plates 131 are not separated from the second vibration plate 132, and the plurality of first vibration plates 131 and the second vibration plate 132 are formed by a continuous member. Therefore, it is easy to make the first vibration plate 131 and the second vibration plate 132 adjacent to each other. Therefore, the plurality of pressure chambers S1 and the absorption chamber S2 are easily adjacent to each other. Since the plurality of pressure chambers S1 and the absorption chamber S2 can be made adjacent to each other, it is possible to enhance the absorption efficiency of the vibration of the ink.

The vibration plate 13 is manufactured by processing a semiconductor substrate such as a single crystal substrate of silicon, for example. The vibration plate 13 may be formed by a portion of the pressure chamber substrate 12. For example, the vibration plate 13 may be formed by thinning a portion of the second substrate 122.

The sealing substrate 14 is disposed on the surface of the vibration plate 13 in the Z2 direction. The sealing substrate 14 is a structure that protects a plurality of the first piezoelectric elements 3 and a plurality of second piezoelectric elements 5 which will be described later and reinforces the mechanical strength of the pressure chamber substrate 12.

A third communication flow path R3, a first space H1, a second space H2, and a wiring space H0 are formed in the sealing substrate 14. The sealing substrate 14 has a recess or a through-hole, and each flow path or space is formed by the recess or the through-hole. Each of the third communication flow path R3 and the wiring space H0 is a hole penetrating the sealing substrate 14. The first space H1 and the second space H2 are spaces surrounded by recesses formed in the sealing substrate 14.

The third communication flow path R3 overlaps the second communication flow path R2 in a plan view, and is coupled to the second communication flow path R2. A common ink chamber R is formed in the third communication flow path R3 and the second communication flow path R2. The common ink chamber R functions as a reservoir. A filter 141 that removes air bubbles and foreign matters contained in the ink is provided in a portion overlapping the common ink chamber R in a plan view. The filter 141 may be omitted.

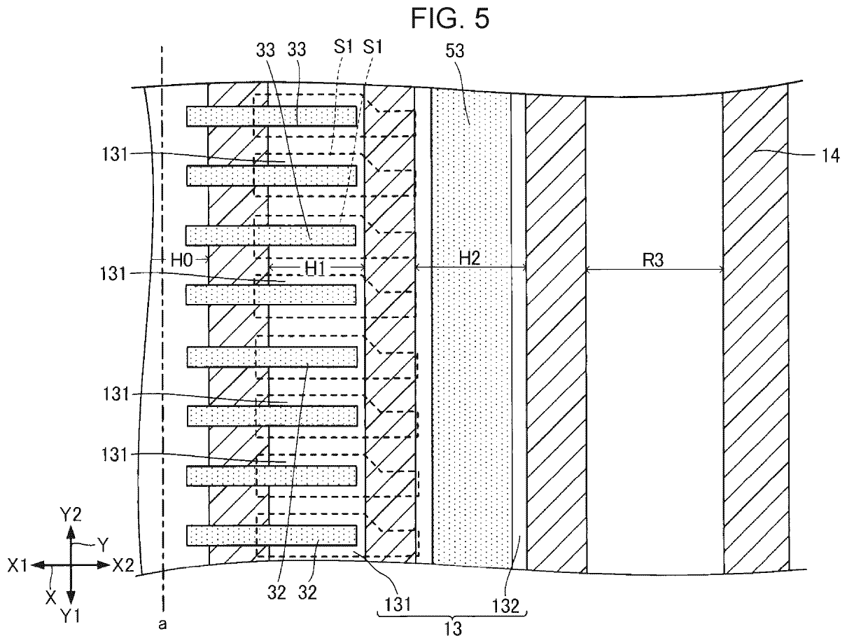

FIG. 5 is a plan view illustrating a portion of the sealing substrate 14 in FIG. 3. In FIG. 5, for convenience, dots are added to the second electrode 33 of the first piezoelectric element 3 and the third electrode 52 of the second piezoelectric element 5.

As illustrated in FIG. 5, each of the first space H1, the second space H2, the third communication flow path R3, and the wiring space H0 has a longitudinal shape extending in the Y2 direction. The wiring space H0, the first space H1, the second space H2, and the third communication flow path R3 are arranged in this order in the X2 direction.

As illustrated in FIG. 3, a plurality of first piezoelectric elements 3 are disposed in the first space H1. The second piezoelectric element 5 is disposed in the second space H2. The wiring substrate 49 is disposed in the wiring space H0. The wiring substrate 49 is bonded to the pressure chamber substrate 12. The wiring substrate 49 is a mounting component on which a plurality of wirings for electrically coupling the control unit 20 and the liquid ejecting head 1 are formed. As the wiring substrate 49, for example, a tape carrier package (TCP), a flexible printed circuit (FPC), or the like is used.

Each of the first piezoelectric elements 3 has a longitudinal shape extending in the X2 direction. The plurality of first piezoelectric elements 3 are spaced apart from each other and are arranged in the Y2 direction. The plurality of first piezoelectric elements 3 are provided in a one-to-one relationship with the plurality of pressure chambers S1. The second piezoelectric element 5 has a longitudinal shape extending in the Y2 direction and extends in a direction intersecting the plurality of first piezoelectric elements 3. The second piezoelectric element 5 is provided corresponding to the absorption chamber S2 and overlaps the absorption chamber S2 in a plan view.

The first piezoelectric element 3 is provided corresponding to the pressure chamber S1. Specifically, the first piezoelectric element 3 is disposed on the surface of the first vibration plate 131 opposite to the pressure chamber S1 for each pressure chamber S1. The first piezoelectric element 3 is an energy generation element that generates energy for ejecting the ink by application of the drive signal Com. In addition, the first piezoelectric element 3 is also a drive element that drives by the application of the drive signal Com. The first piezoelectric element 3 contracts when a voltage is applied, bends the first vibration plate 131, and pressurizes the pressure chamber S1.

The first piezoelectric element 3 schematically includes the second electrode 33, the first piezoelectric member 31, and the first electrode 32. The second electrode 33, the first piezoelectric member 31, and the first electrode 32 are stacked in this order from the first vibration plate 131. Thus, the first electrode 32 is located in the Z2 direction, which is an “upward direction” in the “one side in the up-down direction” with respect to the first piezoelectric member 31. The second electrode 33 is located in the Z1 direction, which is a “downward direction” in the “other side in the up-down direction” with respect to the first piezoelectric member 31. By providing the first electrode 32 and the second electrode 33, the pressure is efficiently applied to the first piezoelectric member 31. The second electrode 33 and the first vibration plate 131 may be in contact with each other, and another member may be interposed between the second electrode 33 and the first vibration plate 131.

The first piezoelectric member 31 is a dielectric member that is individually provided for each of the plurality of first piezoelectric elements 3. The plurality of first piezoelectric members 31 may be coupled to each other. For example, the plurality of first piezoelectric members 31 may be separated by forming a plurality of notches in a band-shaped dielectric film extending along the Y2 direction. Thus, the plurality of first piezoelectric members 31 may be formed by one dielectric film. The first piezoelectric member 31 is formed of a known piezoelectric material such as lead zirconate titanate (Pb(Zr,Ti)O₃), for example.

The first electrode 32 is a common electrode provided in common for the plurality of first piezoelectric members 31. The first electrode 32 has a band shape that extends in the Y2 direction to be continuous over the plurality of first piezoelectric elements 3. The second electrodes 33 are provided in common for the plurality of pressure chambers S1. Since the second electrode 33 is provided in common for the plurality of pressure chambers S1, it is easier to thin the first piezoelectric element 3 as compared to the case where the second electrode 33 is individually provided. The first electrode 32 is formed of, for example, a low-resistance conductive material such as platinum (Pt) or iridium (Ir), similar to the second electrode 33.

As illustrated in FIG. 5, the second electrode 33 is elongated along the X-axis. The plurality of second electrodes 33 are arranged along the Y-axis. The second electrodes 33 are individual electrodes formed to be spaced apart from each other for each first piezoelectric element 3. The second electrodes 33 are individually provided for the plurality of pressure chambers S1. By being individually provided, even when the plurality of first piezoelectric members 31 are formed by one dielectric film, one dielectric film can be divided into the plurality of first piezoelectric members 31. The second electrode 33 is formed of a conductive material such as platinum or iridium, for example.

The first piezoelectric element 3 is a piezoelectric element related to ejection of the ink. A reference voltage, which is a constant voltage, is applied to the first electrode 32. The reference voltage may be, for example, a ground voltage or a voltage higher than the ground voltage. The drive signal Com is supplied to the second electrode 33. As a result, a drive voltage that changes with time is applied to the second electrode 33.

A voltage corresponding to a difference between the reference voltage applied to the first electrode 32 and the drive voltage supplied to the second electrode 33 is applied to the first piezoelectric member 31. Thus, the drive circuit 40 described above in FIG. 2 applies the drive voltage that changes with time to the first piezoelectric member 31. Since the voltage corresponding to the difference between the reference voltage applied to the first electrode 32 and the drive voltage supplied to the second electrode 33 is applied to the first piezoelectric member 31, the first piezoelectric element 3 generates energy that bends and deforms the first vibration plate 131. As a result, the first piezoelectric element 3 applies pressure to the pressure chamber SI by the application of the voltage. Since the first vibration plate 131 is bent and deformed by the energy generated by the first piezoelectric element 3, the pressure in the pressure chamber S1 changes, and the ink in the pressure chamber S1 is ejected from the nozzle N illustrated in FIG. 3.

The second piezoelectric element 5 illustrated in FIG. 3 is provided corresponding to the absorption chamber S2. Specifically, the second piezoelectric element 5 is disposed on the surface of the first vibration plate 131 opposite to the absorption chamber S2. The second piezoelectric element 5 is used to detect the pressure of the absorption chamber S2. The second piezoelectric element 5 is deformed in response to the second vibration plate 132 that bends in accordance with the pressure of the absorption chamber S2.

The second piezoelectric element 5 includes a fourth electrode 53, a second piezoelectric member 51, and a third electrode 52. The fourth electrode 53, the second piezoelectric member 51, and the third electrode 52 are stacked in this order from the second vibration plate 132. The fourth electrode 53 and the second vibration plate 132 may be in contact with each other, and another member may be interposed between the fourth electrode 53 and the second vibration plate 132.

The second piezoelectric member 51 is a band-shaped dielectric film extending in the Y2 direction. The second piezoelectric member 51 is formed of a known piezoelectric material such as lead zirconate titanate, for example. The thickness of the second piezoelectric member 51 is the same as the thickness of the first piezoelectric member 31. The thickness is a length in the Z1 direction. In addition, each of the third electrode 52 and the fourth electrode 53 is elongated along the Y-axis. Each of the third electrode 52 and the fourth electrode 53 is formed of a conductive material such as platinum or iridium, for example.

FIG. 5 illustrates the fourth electrode 53. The planar area of each of the third electrode 52 and the second piezoelectric member 51 is substantially the same as the planar area of the fourth electrode 53, and the third electrode 52 and the second piezoelectric member 51 overlap the fourth electrode 53 in a plan view. In addition, the second piezoelectric member 51, the third electrode 52, and the fourth electrode 53 substantially overlap the entire region of the absorption chamber S2 in a plan view.

As described above, in the liquid ejecting head 1 in the present embodiment, the pressure chamber S1 and the absorption chamber S2 are provided in the pressure chamber substrate 12, and the pressure chamber S1 and the absorption chamber S2 are adjacent to each other. In the form in which the pressure chamber S1 and the absorption chamber S2 are adjacent to each other, the second piezoelectric member 51 is provided corresponding to the absorption chamber S2. The liquid ejecting head 1 is provided with the pressure acquisition portion 42 that acquires the pressure of the absorption chamber S2 based on the voltage applied to the second piezoelectric member 51.

As described above, the absorption chamber S2 is a space for absorbing the vibration of the ink generated when the pressure is applied to the ink in the pressure chamber S1. By providing the absorption chamber S2, it is possible to stabilize the ejection performance of the ink. In the present embodiment, the second piezoelectric member 51 is provided corresponding to the absorption chamber S2, and thus it is possible to detect the pressure of the absorption chamber S2 based on the voltage applied to the second piezoelectric member 51. Therefore, it is possible to detect the pressure in the vicinity of the pressure chamber S1 by using the absorption chamber S2. Therefore, it is possible to detect the pressure in the vicinity of the pressure chamber SI with a simple configuration without separately forming a space or the like for detecting the pressure in the vicinity of the pressure chamber S1. Since the pressure of the absorption chamber S2 in the vicinity of the pressure chamber S1 can be acquired, it is possible to detect the behavior of the ink according to the pressure of the pressure chamber S1. Therefore, for example, it is possible to detect whether or not various problems such as insufficient supply of the ink to the plurality of pressure chambers S1 and absorption chambers S2 have occurred. As a result, since the pressure of the absorption chamber S2 in the vicinity of the pressure chamber S1 can be acquired, it is possible to contribute to the improvement in quality of the liquid ejecting head 1.

Further, the absorption chamber S2 is not directly related to the ink ejection as in the pressure chamber S1. Therefore, it is possible to normally detect the pressure of the absorption chamber S2 based on the voltage applied to the second piezoelectric member 51 regardless of the ink ejection.

In the present embodiment, electrostatic capacitance C2 is acquired based on the voltage applied to the second piezoelectric member 51, and the pressure of the absorption chamber S2 is detected based on the electrostatic capacitance C2.

The electrostatic capacitance C2 changes with the pressure of the absorption chamber S2. Specifically, when the pressure in the absorption chamber S2 changes, the second vibration plate 132 is deformed in response to the change in the pressure. The second vibration plate 132 is deformed to bend in the Z1 direction or the Z2 direction. When the second vibration plate 132 is deformed, stress is applied to the second piezoelectric member 51 on the second vibration plate 132. The polarization state of the second piezoelectric member 51 changes due to the stress applied to the second piezoelectric member 51. The change in the polarization state appears as a change in the dielectric constant & of the second piezoelectric member 51, and thus the electrostatic capacitance C changes. Thus, the electrostatic capacitance C changes in response to the change in the pressure of the absorption chamber S2.

The electrostatic capacitance C is represented by the expression [1].

$$C = ε ( S / d \qquad [ 1 ]$$

S is an electrode area. d is a distance between the third electrode 52 and the fourth electrode 53.

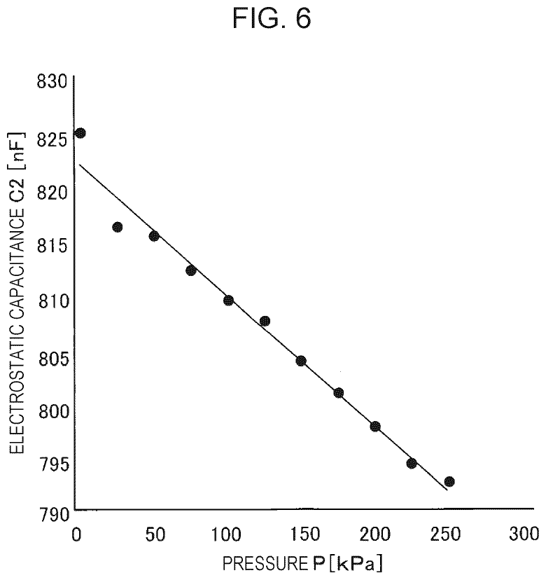

FIG. 6 is a graph illustrating an example of a relationship between the electrostatic capacitance C2 and pressure P of the second piezoelectric member 51. In FIG. 6, the horizontal axis is the pressure P [kPa], and the vertical axis is the electrostatic capacitance C2 [nF]. In the example illustrated in FIG. 6, the electrostatic capacitance C of the second piezoelectric member 51 decreases as the pressure P increases.

As illustrated in FIG. 6, since the electrostatic capacitance C2 of the second piezoelectric member 51 and the pressure P have a correlation, it is possible to detect the pressure of the absorption chamber S2 based on the electrostatic capacitance C2 by using the second piezoelectric member 51. The pressure acquisition portion 42 described above in FIG. 2 acquires the electrostatic capacitance C2 of the second piezoelectric member 51 based on the voltage applied to the second piezoelectric member 51, and acquires the pressure of the absorption chamber S2 based on the electrostatic capacitance C2. By providing the second piezoelectric member 51 and the pressure acquisition portion 42, it is possible to detect the pressure of the absorption chamber S2 based on the electrostatic capacitance C2, and thus it is possible to detect a minute change in pressure.

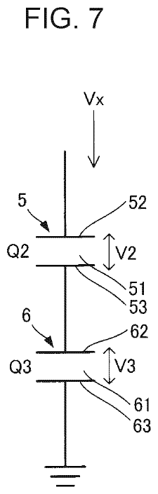

FIG. 7 is a view illustrating the second piezoelectric element 5 and the third piezoelectric element 6 in FIG. 2. The third piezoelectric element 6 illustrated in FIG. 7 is a reference piezoelectric element. The third piezoelectric element 6 is coupled in series to the second piezoelectric element 5. The third piezoelectric element 6 is not disposed on the above-described vibration plate 13, and is provided at a portion that is not deformed by the pressure in the flow path.

The third piezoelectric element 6 has the similar configuration to the second piezoelectric element 5. The third piezoelectric element 6 includes a third piezoelectric member 61, a fifth electrode 62, and a sixth electrode 63. The third piezoelectric member 61 is interposed between the fifth electrode 62 and the sixth electrode 63. The third piezoelectric member 61 is a dielectric member, and is formed of a known piezoelectric material such as lead zirconate titanate. The electrostatic capacitance of the third piezoelectric member 61 is known.

Each of the fifth electrode 62 and the sixth electrode 63 is formed of a conductive material such as platinum or iridium, for example. The fifth electrode 62 is electrically coupled to the fourth electrode 53 of the second piezoelectric element 5. A constant predetermined voltage is applied to the sixth electrode 63. In the example illustrated in FIG. 7, the predetermined voltage is a ground voltage, and the sixth electrode 63 is grounded. In addition, a constant predetermined voltage Vx different from the voltage applied to the sixth electrode 63 is applied to the third electrode 52 of the second piezoelectric element 5 described above. Thus, the voltage applying portion 41 in FIG. 2 applies the predetermined voltage Vx to the second piezoelectric member 51 and the third piezoelectric member 61.

The electrostatic capacitance C2 of the second piezoelectric member 51 can be obtained based on a voltage V2 applied to the second piezoelectric member 51, a voltage V3 applied to the third piezoelectric member 61, and electrostatic capacitance C3 of the third piezoelectric member 61, as shown in the following [4].

$$V 2 = C 2 \times Q 2 \qquad [ 2 ]$$

$$V 3 = C 3 \times Q 3 \qquad [ 3 ]$$

$$C 2 = ( V 2 / V 3 ) \times C 3 \qquad [ 4 ]$$

The expression [4] is derived from the expression [2] and the expression [3]. Q2 is charges generated in the second piezoelectric element 5, and Q3 is charges generated in the third piezoelectric element 6. The voltage V2 is a voltage applied to the second piezoelectric member 51 when the predetermined voltage Vx is applied by the voltage applying portion 41. The voltage V3 is a voltage applied to the third piezoelectric member 61 when the predetermined voltage Vx is applied by the voltage applying portion 41.

When stress is applied to the second piezoelectric member 51 and the electrostatic capacitance C2 of the second piezoelectric member 51 changes, the voltage V2 applied to the second piezoelectric member 51 changes. The pressure acquisition portion 42 in FIG. 2 acquires a signal of the voltage V2. The electrostatic capacitance C2 of the second piezoelectric member 51 is obtained by using the voltage V2, the voltage V3, and the known electrostatic capacitance C3 with the expression [4]. Thus, the pressure acquisition portion 42 acquires the electrostatic capacitance C2 based on the voltage V2, the voltage V3, and the electrostatic capacitance C3. The pressure P of the second piezoelectric member 51 is obtained from the electrostatic capacitance C2 and the correlation between the electrostatic capacitance C2 and the pressure P illustrated in FIG. 6. In this manner, the pressure acquisition portion 42 acquires the pressure of the absorption chamber S2 based on the electrostatic capacitance C2.

In the present embodiment, as described above, the pressure acquisition portion 42 obtains the electrostatic capacitance C2 of the second piezoelectric member 51 by using the third piezoelectric member 61 having the known electrostatic capacitance C3, and detects the pressure of the absorption chamber S2 from the electrostatic capacitance C2. According to the detection method using the third piezoelectric member 61, it is possible to detect the pressure of the absorption chamber S2 in the vicinity of the pressure chamber S1 with a simple configuration. The method of detecting the pressure of the absorption chamber S2 is not limited to the detection method using the third piezoelectric member 61, and the third piezoelectric element 6 may be omitted depending on the detection method.

Further, as described above, at least the plurality of pressure chambers S1 and one absorption chamber S2 that is commonly coupled to the plurality of pressure chambers S1 are provided in the pressure chamber substrate 12. Since the volume of the absorption chamber S2 is larger than the volume of each pressure chamber S1, it is possible to make the planar area of the second vibration plate 132 that forms the absorption chamber S2 be larger than the planar area of each first vibration plate 131 that forms each pressure chamber S1. Therefore, it is possible to make the displacement of the second vibration plate 132 be larger than the displacement of the first vibration plate 131. Therefore, it is possible to enhance the absorption efficiency by the absorption chamber S2. Further, since it is possible to detect the pressure of one absorption chamber S2 commonly coupled to the plurality of pressure chambers S1, it is possible to detect the pressure of the absorption chamber S2 due to the influence of the plurality of pressure chambers S1, instead of the pressure of each pressure chamber S1. As a result, it is possible to use the pressure for problem detection, for example, detection as to whether or not various problems such as insufficient ink supply have occurred.

In addition, as illustrated in FIG. 5, the second electrode 33 extends in the X2 direction. The fourth electrode 53 extends in the Y2 direction. The Y2 direction, which is the “first direction”, is a direction in which a plurality of pressure chambers are arranged. The X2 direction, which is the “second direction”, is a direction in which each pressure chamber S1 and the absorption chamber S2 are arranged.

A direction in which the first piezoelectric member 31 is easily bent is different from a direction in which the second piezoelectric member 51 is easily bent. The pressure chamber S1, the first piezoelectric member 31, and the second electrode 33 are elongated along the X2 direction. When the exclusion volume of the pressure chamber S1 is made as large as possible while the pressure chamber SI extends in the X2 direction, the first piezoelectric member 31 and the second electrode 33 are also likely to extend in the X2 direction. Therefore, each of the first piezoelectric member 31 and the second electrode 33 is easily bent around the vicinity of the center in the X2 direction. Thus, by providing the first piezoelectric member 31 along an extension direction of the pressure chamber S1, it is possible to enhance the discharge accuracy.

On the other hand, the absorption chamber S2, the second piezoelectric member 51, and the fourth electrode 53 are elongated along the Y2 direction. Therefore, each of the second piezoelectric member 51 and the fourth electrode 53 is easily bent around the vicinity of the center in the Y2 direction. The absorption chamber S2 is provided in common for the plurality of pressure chambers S1, and pressure is commonly applied from the plurality of pressure chambers SI to the absorption chamber S2. It is difficult to assume that the pressure is intensively applied only from the specific pressure chamber S1. From this viewpoint, each of the second piezoelectric member 51 and the fourth electrode 53 is easily bent around the vicinity of the center in the Y2 direction. As a result, by providing the second piezoelectric member 51 along an extension direction of the absorption chamber S2, it is possible to enhance the pressure detection sensitivity.

For example, the second piezoelectric member 51 and the fourth electrode 53 may be disposed along the X2 direction. However, in this case, the bending amount of the second piezoelectric member 51 and the fourth electrode 53 is smaller than the bending amount when the second piezoelectric member 51 and the fourth electrode 53 are disposed along the X2 direction.

Further, as illustrated in FIG. 5, the fourth electrode 53 overlaps the center of the absorption chamber S2 in the X2 direction. Similarly, the second piezoelectric member 51 overlaps the center of the absorption chamber S2 in the X2 direction. Therefore, the fourth electrode 53 and the second piezoelectric member 51 overlap the center of the second vibration plate 132 in the X2 direction. The center of the second vibration plate 132 in the X2 direction is a portion that is displaced most. Therefore, since the fourth electrode 53 and the second piezoelectric member 51 overlap the center of the absorption chamber S2 in the X2 direction, it is possible to enhance the detection accuracy of the pressure of the absorption chamber S2. The fourth electrode 53 and the second piezoelectric member 51 may not overlap the center in the X2 direction.

According to the above-described embodiment, it is possible to acquire the pressure in the vicinity of the pressure chamber S1 by using the absorption chamber S2 which is a space for absorbing the vibration of the ink.

### 2. Second Embodiment

A second embodiment will be described. In the aspects illustrated below, elements having the same effects or functions as those of the first embodiment described above will be given the reference numerals used in the description of the first embodiment described above, and each of the detailed descriptions thereof will be appropriately omitted.

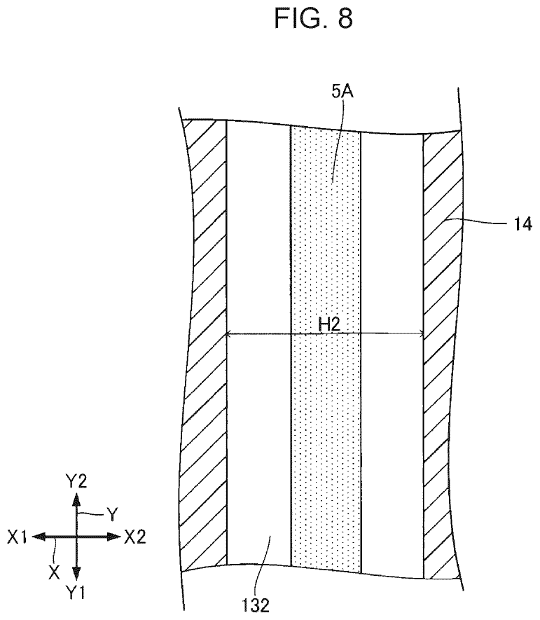

FIG. 8 is a plan view illustrating a second piezoelectric element 5A in the second embodiment. The second piezoelectric element 5A illustrated in FIG. 8 does not overlap the entire region of the absorption chamber S2 in a plan view. Thus, the second piezoelectric member 51 of the second piezoelectric element 5A is not provided in the entire region of the absorption chamber S2 in a plan view. For example, the length of the second piezoelectric member 51 in the X2 direction is equal to or less than half the length of the absorption chamber S2 and the second vibration plate 132 in the X2 direction.

Since the second piezoelectric member 51 is not provided in the entire region of the absorption chamber S2 in a plan view, the second vibration plate 132 is easily deformed as compared with the case where the second piezoelectric member 51 is provided in the entire region. By providing the second piezoelectric member 51 to overlap the center of the second vibration plate 132 in the X2 direction that is displaced the easiest, it is possible to enhance the detection accuracy of the pressure of the absorption chamber S2.

### 3. Third Embodiment

A third embodiment will be described. In the aspects illustrated below, elements having the same effects or functions as those of the first embodiment described above will be given the reference numerals used in the description of the first embodiment described above, and each of the detailed descriptions thereof will be appropriately omitted.

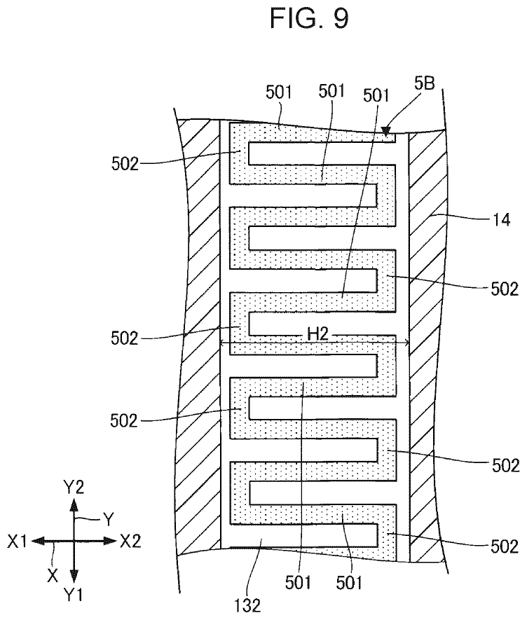

FIG. 9 is a plan view illustrating a second piezoelectric element 5B in the third embodiment. The second piezoelectric element 5B illustrated in FIG. 9 has a bellows shape that is sequentially folded toward the Y2 direction while extending along the X2 direction.

The second piezoelectric element 5B includes a plurality of first portions 501 and a plurality of second portions 502. The plurality of first portions 501 are portions extending in the X2 direction, and are arranged in the Y2 direction to be spaced apart from each other. The plurality of second portions 502 are portions extending in the Y2 direction. Each second portion 502 is disposed between two adjacent first portions 501 and couples the two adjacent first portions 501. The plurality of second portions 502 are alternately disposed at the end of the first portion 501 in the X1 direction and the end of the first portion 501 in the X2 direction. The plurality of second portions 502 are counted in the Y2 direction by setting the second portion 502 located foremost in the Y1 direction among the plurality of second portions 502 to be the first. In this case, for example, the odd-numbered second portion 502 among the plurality of second portions 502 is coupled to the end of the first portion 501 in the X2 direction. The even-numbered second portion 502 among the plurality of second portions 502 is coupled to the end of the first portion 501 in the X1 direction.

The length of one first portion 501 is longer than the length of one second portion 502. As a result, the second piezoelectric element 5B has a shape in which the second piezoelectric element 5B is bent alternately in the X1 direction and the X2 direction by the first portions 501, and is gradually shifted along the Y2 direction by the second portions 502, and thus the second piezoelectric element 5B extends along the Y2 direction as a whole. Such a shape is referred to as a shape of “being folded sequentially while extending along the X2 direction”.

The second piezoelectric member 51, the third electrode 52, and the fourth electrode 53 of the second piezoelectric element 5B are configured to have a bellows shape that is folded sequentially while extending along the X2 direction. Since the second piezoelectric element 5B has a bellows shape, the second piezoelectric element 5B is more likely to receive stress due to the deformation of the second vibration plate 132 than when the second piezoelectric element 5B is elongated along the Y2 direction as with the second piezoelectric element 5 in the first embodiment. In addition, since the second piezoelectric element 5B has a bellows shape, the planar area is reduced as compared with the second piezoelectric element 5 in the first embodiment. As a result, the volume of the second piezoelectric element 5 on the second vibration plate 132 is reduced. Therefore, the second vibration plate 132 is easily deformed. Therefore, it is possible to enhance the detection accuracy of the pressure of the absorption chamber S2.

The shape of the second piezoelectric element 5 is preferably a shape that is likely to receive stress due to deformation of the second vibration plate 132, and is not limited to the illustrated bellows shape.

### 4. Modification Example

The embodiments described above may be variously modified. A specific modification form that can be applied to the above-described embodiment will be described below. Two or more forms freely selected from the following examples can be appropriately combined in a range without contradictory.

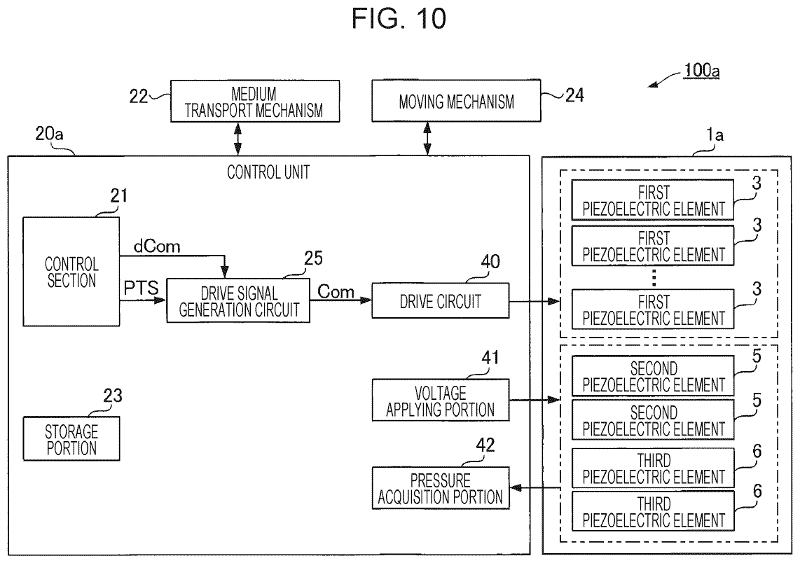

FIG. 10 is a block diagram of a liquid ejecting apparatus 100a in a modification example. The liquid ejecting apparatus 100a includes a liquid ejecting head 1a and a control unit 20a. The drive circuit 40, the voltage applying portion 41, and the pressure acquisition portion 42 are provided in the control unit 20a. The voltage applying portion 41 and the pressure acquisition portion 42 are not provided in the liquid ejecting head 1a.

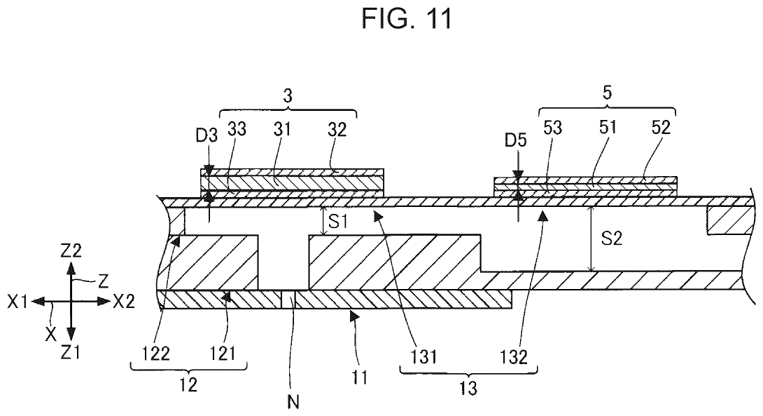

As illustrated in FIG. 11, each of the drive circuit 40, the voltage applying portion 41, and the pressure acquisition portion 42 may be provided in the control unit 20 in part or in whole. Also with the liquid ejecting apparatus 100a, the pressure in the vicinity of the pressure chamber S1 can be acquired by using the absorption chamber S2 which is a space for absorbing the vibration of the ink, as in each of the embodiments.

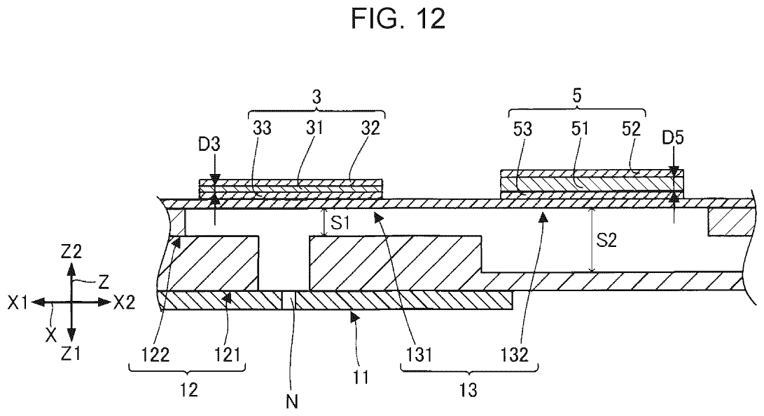

FIGS. 11 and 12 are cross-sectional views of the first piezoelectric element 3 and the second piezoelectric element 5 in the modification example. The thickness D5 of the second piezoelectric member 51 of the second piezoelectric element 5 may be different from the thickness D3 of the first piezoelectric member 31 of the first piezoelectric element 3.

For example, in FIG. 11, the thickness D5 of the second piezoelectric member 51 is thinner than the thickness D3 of the first piezoelectric member 31. By making the thickness thinner, the second piezoelectric member 51 is more likely to be deformed than the first piezoelectric member 31. The first piezoelectric member 31 works actively, and the second piezoelectric member 51 works passively. Therefore, since the thickness D5 is thinner than the thickness D3, it is possible to enhance the detection accuracy of the pressure of the absorption chamber S2 as compared with the case where the thickness D5 is thick. On the other hand, the first piezoelectric member 31 is a portion that contributes to the ejection. Therefore, by making the thickness D3 thicker than the thickness D5, it is possible to reduce an occurrence of cracks and the like.

For example, in FIG. 12, the thickness D5 of the second piezoelectric member 51 is thicker than the thickness D3 of the first piezoelectric member 31. Since the thickness D5 is thicker than the thickness D3, that is, the thickness D3 is thinner than the thickness D5, the first piezoelectric member 31 is likely to be deformed than the second piezoelectric member 51. Therefore, it is possible to enhance the ejection performance of the ink.

In addition, the “liquid ejecting head” may be a circulation type head having a so-called circulation flow path.

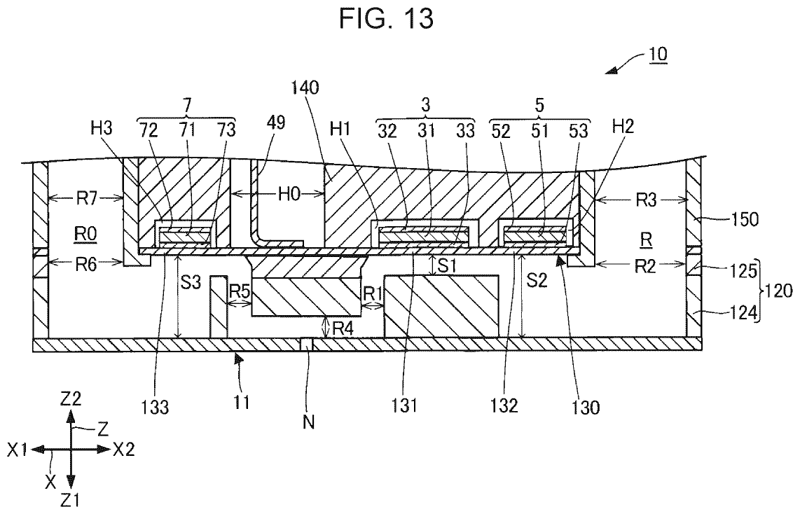

FIG. 13 is a partial cross-sectional view of a liquid ejecting head 10 in the modification example. The liquid ejecting head 10 illustrated in FIG. 13 includes a nozzle substrate 11, a pressure chamber substrate 120, a vibration plate 130, a sealing substrate 140, a case 150, a wiring substrate 49, a first piezoelectric element 3, a second piezoelectric element 4, and a fourth piezoelectric element 7. The liquid ejecting head 10 in FIG. 13 is a circulation type head having a so-called circulation flow path.

The pressure chamber substrate 120 is a laminate of a third substrate 124 and a fourth substrate 125. These substrates are manufactured by processing a semiconductor substrate such as a single crystal substrate of silicon, for example. A plurality of fourth communication flow paths R4, a plurality of fifth communication flow paths R5, a sixth communication flow path R6, and a discharge-side absorption chamber S3 are formed in the pressure chamber substrate 120 in addition to a plurality of pressure chambers S1, an absorption chamber S2, a plurality of first communication flow paths R1, and a second communication flow path R2. The absorption chamber S2 is a supply-side absorption chamber.

One of the first communication flow paths R1 communicates with one of the fifth communication flow paths R5 via one of the fourth communication flow paths R4. Each of the fourth communication flow paths R4 overlaps the nozzle N in a plan view. Each of the fifth communication flow paths R5 communicates with the discharge-side absorption chamber S3. The discharge-side absorption chamber S3 overlaps the fourth piezoelectric element 7 in a plan view. The plurality of discharge-side absorption chambers S3 communicate with the sixth communication flow path R6.

The vibration plate 130 includes a third vibration plate 133 in addition to the plurality of first vibration plates 131 and the second vibration plate 132. The third vibration plate 133 is a portion of the vibration plate 130, which overlaps the discharge-side absorption chamber S3 in a plan view.

The case 150 is in contact with the sealing substrate 140. The case 150 and the sealing substrate 140 may be integrated. The third communication flow path R3 and the seventh communication flow path R7 are formed in the case 150. The common ink chamber R0 is formed in the seventh communication flow path R7 and the sixth communication flow path R6.

A third space H3 is formed in the sealing substrate 140 in addition to the first space H1, the second space H2, and the wiring space H0. The fourth piezoelectric element 7 is disposed in the third space H3. The fourth piezoelectric element 7 is disposed on the surface of the third vibration plate 133 opposite to the discharge-side absorption chamber S3. The fourth piezoelectric element 7 is used to detect the pressure of the discharge-side absorption chamber S3. The fourth piezoelectric element 7 is deformed in response to the third vibration plate 133 that bends in accordance with the pressure of the discharge-side absorption chamber S3.

The fourth piezoelectric element 7 includes a seventh electrode 72, a third piezoelectric member 71, and an eighth electrode 73. These components are elongated along the Y-axis. The eighth electrode 73, the third piezoelectric member 71, and the seventh electrode 72 are stacked in this order from the third vibration plate 133. The third piezoelectric member 71 is formed of a known piezoelectric material such as lead zirconate titanate, for example. Each of the seventh electrode 72 and the eighth electrode 73 is formed of a conductive material such as platinum or iridium, for example. The fourth piezoelectric element 7 is not provided for applying pressure to a liquid in the flow path, but is provided for absorbing the vibration.

The third vibration plate 133, the fourth piezoelectric element 7, and the discharge-side absorption chamber S3 are elongated along the Y-axis and are provided for the plurality of pressure chambers S1, but may be provided for each pressure chamber S1. Thus, a plurality of the third vibration plates 133, a plurality of the fourth piezoelectric elements 7, and a plurality of the discharge-side absorption chambers S3 may be provided.

In the liquid ejecting head 10, the ink flows to the pressure chamber S1 via the common ink chamber R and the absorption chamber S2. The pressure in the pressure chamber S1 fluctuates by driving the first piezoelectric element 3, and the ink is ejected from the nozzle N as ink droplets via the first communication flow path R1 and the fourth communication flow path R4 due to the fluctuation of the pressure. At the same time, the ink flows back through the fifth communication flow path R5, the discharge-side absorption chamber S3, and the common ink chamber R0. In this manner, the ink is circulated.

In addition, in the liquid ejecting head 10, the absorption chamber S2 is provided in the X2 direction with respect to the pressure chamber S1, and the discharge-side absorption chamber S3 is provided in the X1 direction with respect to the pressure chamber S1. That is, a vibration absorption mechanism is provided on the supply side and the discharge side of the ink with respect to the pressure chamber S1. Further, a distance between the absorption chamber S2 and the pressure chamber S1 is shorter than a distance between the discharge-side absorption chamber S3 and the pressure chamber S1. Since the pressure in the vicinity of the pressure chamber S1 is detected by using the absorption chamber S2 closer to the pressure chamber S1, it is possible to detect the behavior and the like of the ink corresponding to the pressure of the pressure chamber SI with higher accuracy.

The “liquid ejecting apparatus” can be adopted in various devices such as a facsimile machine and a copying machine, in addition to a device dedicated to printing. Use of the liquid ejecting apparatus is not limited to printing. For example, a liquid ejecting apparatus that ejects a solution of a coloring material is used as a manufacturing apparatus that forms a color filter of a display apparatus such as a liquid crystal display panel. In addition, a liquid ejecting apparatus that ejects a solution of a conductive material is used as a manufacturing apparatus that forms a wire or an electrode of a wiring substrate. In addition, a liquid ejecting apparatus that ejects a solution of an organic substance related to a living body is utilized as a manufacturing apparatus that manufactures a biochip, for example.

The present disclosure is described based on the preferred embodiments, but the present disclosure is not limited to the above-described embodiments. The configuration of each portion of the present disclosure can be replaced with any configuration that has the same function as the above-described embodiments, and any configuration can be added.

What is claimed is:

1. A liquid ejecting head comprising:
a nozzle substrate that is provided with a nozzle for ejecting a liquid;
a pressure chamber substrate that includes
a pressure chamber in which pressure for ejecting the liquid from the nozzle is applied to the liquid, and
an absorption chamber that is adjacent to the pressure chamber and absorbs vibration of the liquid generated when the pressure is applied to the liquid in the pressure chamber;
a first piezoelectric member that is provided corresponding to the pressure chamber and applies pressure to the pressure chamber when a voltage is applied;
a second piezoelectric member that is provided corresponding to the absorption chamber; and
a pressure acquisition portion that acquires pressure of the absorption chamber based on a voltage applied to the second piezoelectric member.

2. The liquid ejecting head according to claim 1, wherein
the pressure acquisition portion acquires electrostatic capacitance of the second piezoelectric member based on the voltage applied to the second piezoelectric member, and acquires the pressure of the absorption chamber based on the electrostatic capacitance.

3. The liquid ejecting head according to claim 2, further comprising:
a third piezoelectric member that is coupled in series to the second piezoelectric member and has a known electrostatic capacitance; and
a voltage applying portion that applies a predetermined voltage to the second piezoelectric member and the third piezoelectric member, wherein
the pressure acquisition portion acquires the electrostatic capacitance of the second piezoelectric member based on the voltage applied to the second piezoelectric member when the predetermined voltage is applied by the voltage applying portion, a voltage applied to the third piezoelectric member when the predetermined voltage is applied by the voltage applying portion, and the electrostatic capacitance of the third piezoelectric member, and acquires the pressure of the absorption chamber based on the acquired electrostatic capacitance.

4. The liquid ejecting head according to claim 2, further comprising:
a drive circuit that applies a drive voltage that changes with time to the first piezoelectric member.

5. The liquid ejecting head according to claim 1, wherein
a thickness of the second piezoelectric member is different from a thickness of the first piezoelectric member.

6. The liquid ejecting head according to claim 1, wherein
at least a plurality of the pressure chambers and one absorption chamber that is commonly coupled to the plurality of the pressure chambers are provided in the pressure chamber substrate.

7. The liquid ejecting head according to claim 6, further comprising:
a first vibration plate that vibrates when the voltage is applied to the first piezoelectric member to apply pressure to the pressure chamber; and
a second vibration plate that is driven when pressure is applied from the absorption chamber to apply pressure to the second piezoelectric member.

8. The liquid ejecting head according to claim 7, wherein
the first vibration plate and the second vibration plate are not separated from each other and are formed by a continuous member.

9. The liquid ejecting head according to claim 7, further comprising:
a first electrode that is provided in common for the plurality of pressure chambers and is located on one side in an up-down direction with respect to the first piezoelectric member;
a second electrode that is provided individually for the plurality of pressure chambers and is located on another side in the up-down direction with respect to the first piezoelectric member;
a third electrode that is provided for the absorption chamber and is located on the one side in the up-down direction with respect to the second piezoelectric member; and
a fourth electrode that is provided for the absorption chamber and is located on the other side in the up-down direction with respect to the second piezoelectric member.

10. The liquid ejecting head according to claim 9, wherein
the one side is an upward direction of the first piezoelectric member, and
the other side is a downward direction of the first piezoelectric member.

11. The liquid ejecting head according to claim 10, wherein
when a direction in which the plurality of pressure chambers are arranged is set as a first direction and a direction in which the pressure chamber and the absorption chamber are arranged is set as a second direction,
the second electrode extends in the second direction, and
the fourth electrode extends in the first direction.

12. The liquid ejecting head according to claim 11, wherein
the fourth electrode is provided to overlap a center of the absorption chamber in the second direction.

13. The liquid ejecting head according to claim 11, wherein
the fourth electrode is configured to have a bellows shape that is folded sequentially while extending along the second direction.

14. A liquid ejecting apparatus comprising:
a liquid ejecting head including
a nozzle substrate that is provided with a nozzle for ejecting a liquid,
a pressure chamber substrate that includes
a pressure chamber in which pressure for ejecting the liquid from the nozzle is applied to the liquid, and
an absorption chamber that is adjacent to the pressure chamber and absorbs vibration of the liquid generated when the pressure is applied to the liquid in the pressure chamber,
a first piezoelectric member that is provided corresponding to the pressure chamber and applies pressure to the pressure chamber when a voltage is applied, and
a second piezoelectric member that is provided corresponding to the absorption chamber, and
a pressure acquisition portion that acquires pressure of the absorption chamber based on a voltage applied to the second piezoelectric member.
